(19) United States
(12) Patent Application Publication
(10) Pub. No.: US 2007/0234699 A1
(43) Pub. Date: Oct. 11, 2007

(54) Noise reduction of rotary mowers using an acoustical helmholtz resonator array

(75) Inventor: James E. Berkeley, Pineville, NC (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/400,812

(22) Filed: Apr. 7, 2006

(51) Int. Cl. A01D 67/00

(52) U.S. Cl. 56/320.1

(57) ABSTRACT

According to the principles of the present invention, a ride-behind rotary mower having an advantageous construction is provided. The ride-behind rotary mower includes a mobile structure and a plurality of rotary mowing units. Each mowing unit consists of a mower deck, or cover, a rotary blade, and a plurality of acoustic Helmholtz resonators disposed around the periphery of the mowing unit, with an orifice tube positioned adjacent to the travel of the rotary cutting blade. Each resonator is constructed and tuned such that its resonant frequency is generally equal to the blade pass frequency of the rotary blade during normal operation. As such the resonators will generally reduce the noise of the mower during normal operation.

The present invention relates to turf mowers, and to noise reduction of rotary turf mowers using an acoustical Helmholz resonator array.

### GROUND

The statements in this section merely provide background information related to the present disclosure and may not constitute prior art.

Rotary turf mowers are used to mow lawns in a variety of applications ranging from commercial to residential uses. They are relatively simple in operation and cheap to maintain, and occupy a large share of the market for turf mowers today due primarily to those advantages.

Rotary turf mowers, like turf mowers in general, produce a relatively high noise level generated by the mower deck. Mowing a lawn using a rotary turf mower without disturbing others in immediately surrounding areas presents a challenge. Accordingly, in neighborhoods with noise regulations or other restrictive covenants in place, rotary mowers may be restricted from use during selected hours, typically in the middle of the day. This can be especially disruptive for golf course maintenance crews who have little time other than evenings or early mornings to cut the grass of the golf courses. Manufacturers have searched for ways of attenuating the noise output of these mowers to make them less intrusive upon neighbors and others nearby.

Many traditional noise reducing devices or materials have proven impractical for the rotary mower deck environment. Most sound absorbers are made of materials which break down when subjected to the flying grass clippings, debris, moisture, and general turbulence that is common inside a rotary mower deck during operation. Vibration damping materials typically suffer similar shortcomings with respect to durability. Finally, most sound-deadening materials are relatively exotic compared to the materials ordinarily used in production of rotary mowers. This makes the assembly of mowers utilizing these materials more complex and expensive. As such many manufacturers of mowers avoid the costs associated with these materials to gain the advantages in reduced noise outputs of rotary mowers these materials may offer.

As such there is a need for a rotary mower deck that can provide a reduced level of noise during operation, while remaining cost-effective for manufacturing purposes and durable under the use cycles typical of rotary mowers. In this manner rotary mowers may become less intrusive to those nearby while the mower is in use. Additionally, there is a need in the relevant art to provide a rotary turf mower that overcomes the disadvantages of the prior art.

### SUMMARY

The ride-behind rotary mower includes a mobile structure and preferably four ground engaging wheels rotatably coupled to the mobile structure. Any of the four wheels may impart traction movement from the mobile structure for movement on the ground; preferably all four wheels are driven. An internal combustion engine is supported on the mobile structure and outputs a driving force at an output shaft. A plurality of rotary mowing units are operably attached to the mobile structure, and include at least one rotary blade within each unit for cutting grass in the well-known manner. The mowing units may also be movable between a first engaged position used during mowing operation where the blade is positioned at the desired cutting height, and a second disengaged position where the mowing unit is raised up above the top of the grass, for use during startup and transporting the mower. The plurality of mowing positions between the first engaged position and the second disengaged position thus allow for a variety of cutting heights. Each mowing unit is also preferably equipped with a plurality of ground engaging traction members rotatably coupled to the mowing unit. These traction members support each mowing unit in the first engaged position during mowing so as to maintain a steady cutting height relative to the ground. Any adjacent mowing units may also be structurally joined together for greater stability if desired.

Further areas of applicability will become apparent from the detailed description provided hereinafter. It should be understood that the description and specific examples are intended for purposes of illustration only and are not intended to limit the scope of the present teachings.

### BRIEF DESCRIPTION OF THE DRAWINGS

The drawings described herein are for illustration purposes only and are not intended to limit the scope of the present disclosure in any way.

FIG. 1 is a perspective view illustrating a rotary mower according to various embodiments;

FIG. 2A is a bottom view illustrating a rotary mower deck according to various embodiments;

FIG. 2B is a closeup perspective view of a resonator according to various embodiments;

FIG. 3A is a horizontal sectional view of the rotary mower deck of FIG. 2A;

FIG. 3B is a vertical sectional view of the rotary mower deck of FIG. 2A;

FIG. 4 is a cutaway view of a rotary mower deck according to various embodiments;

FIG. 5 is a vertical sectional view of the rotary mower deck of FIG. 4;

FIG. 6 is a bottom view of a rotary mower deck according to various embodiments;

FIG. 7 is a horizontal sectional view of the rotary mower deck of FIG. 6;

FIG. 8 is a vertical sectional view of the rotary mower deck of FIG. 6; and

FIG. 9 is a vertical sectional view of a rotary mower deck according to the principles of a fourth embodiment of the present invention.

### DETAILED DESCRIPTION

The following description is merely exemplary in nature and is in no way intended to limit the present disclosure, its application, or uses. Throughout the specification, like reference numerals will refer to like elements.

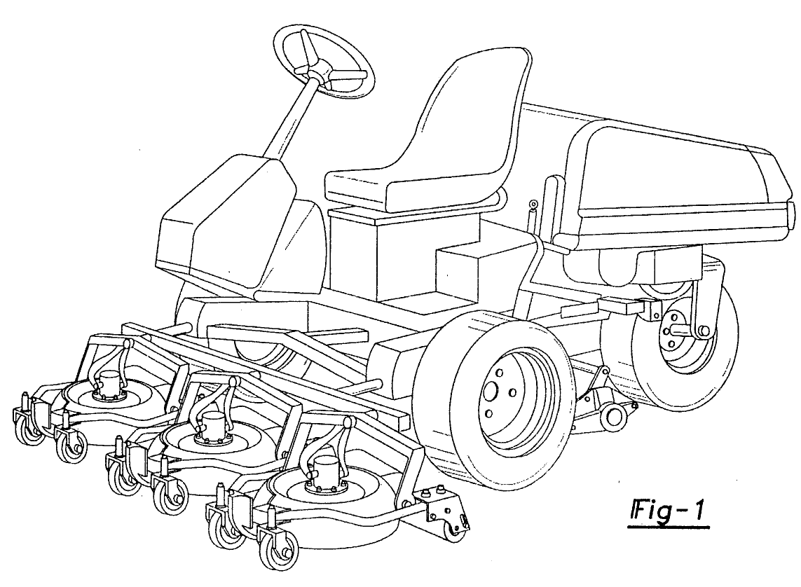

With reference to the figures, FIG. 1 illustrates a ride-behind rotary turf mower 10 according to various embodiments. It should be noted that the present disclosure is also applicable to walk-behind rotary mowers, or any other rotary mower, and the various embodiments should not be construed as part of the disclosure. For the sake of brevity only the ride-behind rotary mower configuration will be discussed below. Turf mower 10 has a main frame 12 and four wheels 24 supporting main frame 12. Main frame 12 may be constructed in a variety of ways well known in the art. Main frame 12 supports an internal combustion engine or electric primary mower (not shown) which is mounted towards the rear of main frame 12, and drives all four wheels 24 through a drivetrain (not shown). Main frame 12 further supports an operator station 26 which includes a driver's seat 28, hand controls 30, and foot controls 32. Main frame 12 also supports a plurality of mowing units: three front mowing units 14, 16, and 18, and two middle mowing units 20 and 22 which are attached beneath main frame 12 between the front and rear wheels 24. It should be noted that turf mower 10 may utilize a different number or configuration of mowing units.

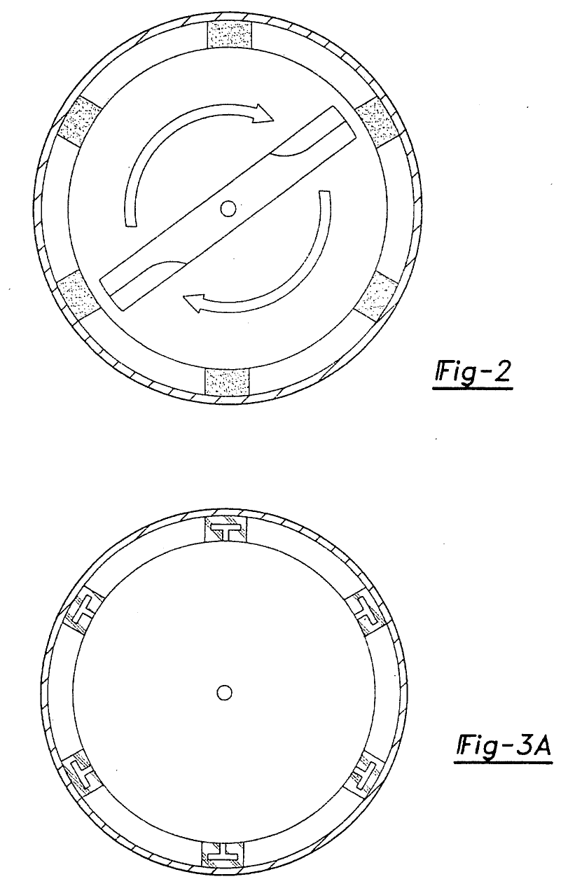

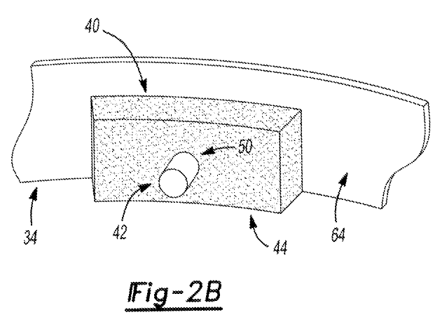

All five mowing units 14, 16, 18, 20, and 22 are constructed in similar fashion. Accordingly, only front mowing unit 18 will be discussed as representative of all mowing units. Each mowing unit includes a mower deck 34, ground engaging wheels or rollers 36, and a rotary blade (not shown) housed by mower deck 34. Turning now to FIG. 2A, a rotary mower deck is illustrated according to various embodiments. Rotary blade 46 is shown at the center of mower deck 34 attached to the end of driveshaft 48 for rotation therewith. Driveshaft 48 may be turned by any mechanical means well known in the art, including electric or hydraulic motors, belts, chains, or the like, thus turning rotary blade 46 for the grass cutting operation.

Mowing unit 18 is shown further comprising six resonators 40 which are mounted to inner surface 64 around the periphery of mower deck 34. As will be obvious, any number of resonators 40 may be provided according to the efficiency of each resonator and the level of noise attenuation desired. Turning to FIGS. 2B, 3A, and 3B resonator 40 is shown. Resonator 40 can be mounted to inner surface 64 in any variety of ways well known in the art, such as welding, gluing or other fastening techniques. Resonator 40 defines an enclosed volume 44 with an orifice 50, and an orifice tube 42 attached atop orifice 50. Enclosed volume 44 may be of quadrangular shape, however other shapes may be utilized as well. Enclosed volume 44 can be assembled from stamped sheetmetal, molded of plastic, or produced in any other method well known in the art. The end of each orifice tube 42 is located adjacent to the end of blade 46 such that the blade passes horizontally near the end of each orifice tube during operation of the mower. During normal operation of mowing unit 18, air is thus moved in and out of the resonator due to the turbulence caused by the motion of rotary blade 46. Resonator 40 is in some embodiments designed such that its resonant frequency f₀ is approximately equal to the blade pass frequency of mowing unit 18 during normal operation. For a single rotary blade configuration such as is illustrated here, resonant frequency f₀ would be approximately equal to twice the rotational speed of the rotary blade. A portion of the noise from blade movement is thus dissipated by the movement of air in and out of resonator 40, reducing the overall noise level of mowing unit 18.

The resonant frequency f₀ the Hemholtz resonator can easily be determined according to the acoustic principle:

$${f}_{0} = \frac{1}{2 π} \sqrt{\frac{{c}^{2} S}{{l}_{e} V}}$$

where:
c=speed of sound;
S=cross sectional area of orifice tube;
lₑ=effective length of the orifice tube; and
V=volume of the resonator.
   As such the resonators will generally cancel at least a portion of the noise of the blade during mowing, thus reducing the overall noise of the mower significantly.

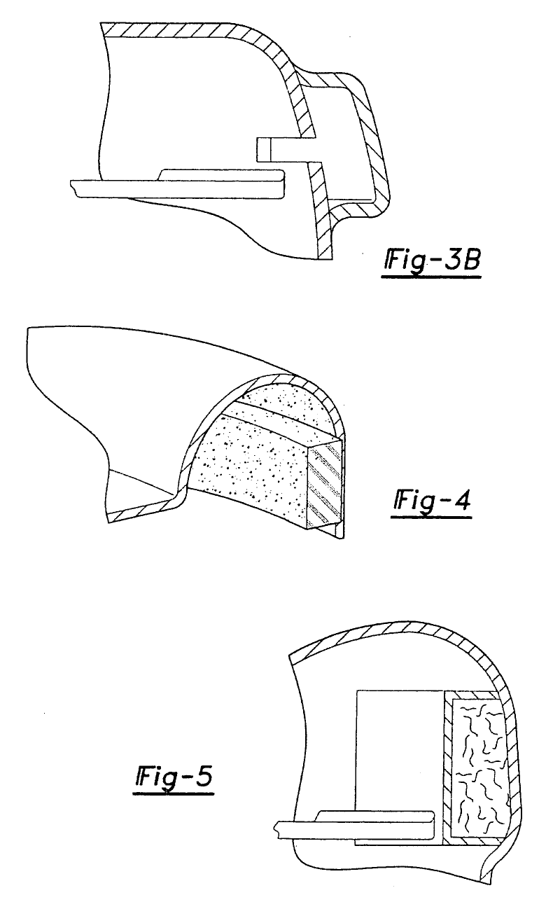

Turning now to FIGS. 4-5, a mower deck according to various embodiments is illustrated. Mowing unit 18 is shown with perforated metal housing 52 positioned around the periphery of mower deck 34. Perforated metal housing 52 has a plurality of small orifices 56 in the sheetmetal defining a perforated pattern. Sound absorbing material 54 is housed within perforated metal housing 52. Perforated metal housing 52 can be attached to mower deck 34 with mechanical means such as screws or clips, or may be glued, or any other attachment means well known in the art. In this manner, perforated metal housing 52 and orifices 56 in perforated metal form a plurality of small resonators which function as described above. Sound absorbing material 54 may be comprised of any variety of sound absorbing materials well known in the art, such as synthetic vitreous fiber material, rock wool, or cotton shoddy. Perforated metal housing 52 provides protection for sound absorbing material 54 from flying debris, which may be common inside mower deck 34 during normal operation. Sound absorbing material 54 performs a sound reducing function beyond that provided by the resonator structure by absorbing the ambient noise inside perforated metal housing 52. This additional noise reducing effect of the presence of sound absorbing material 54 will reduce noise levels of mower deck 34 even during startup, for example, due to the fact that sound absorbing material 54 does not rely upon the blade pass frequency of rotary blade 46 for its sound attenuation function. The size of orifices 56 and the volume of perforated metal housing 52 will have to be designed such that a resonant frequency of the assembled perforated metal housing 52 is approximately equal to a blade pass frequency of rotary blade 46 during normal operation of the mower.

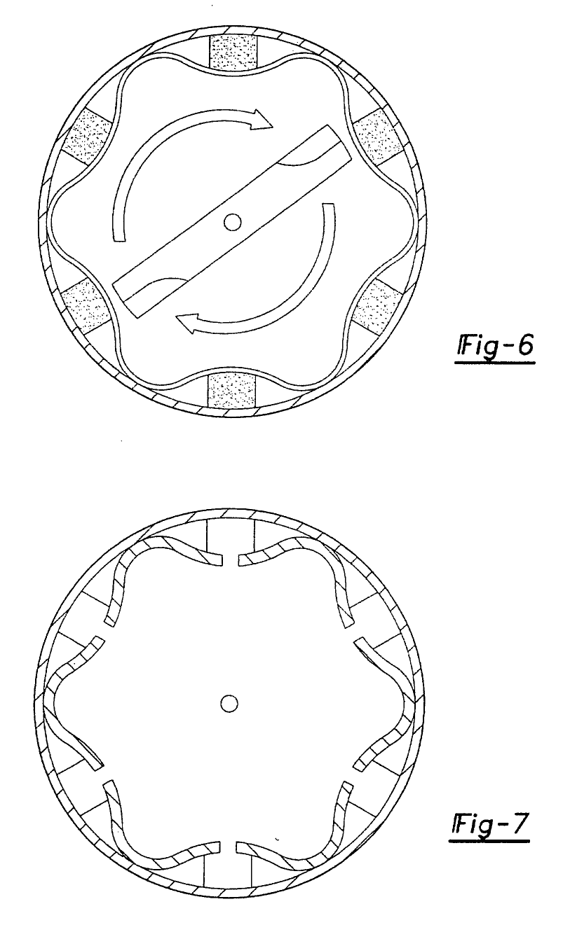

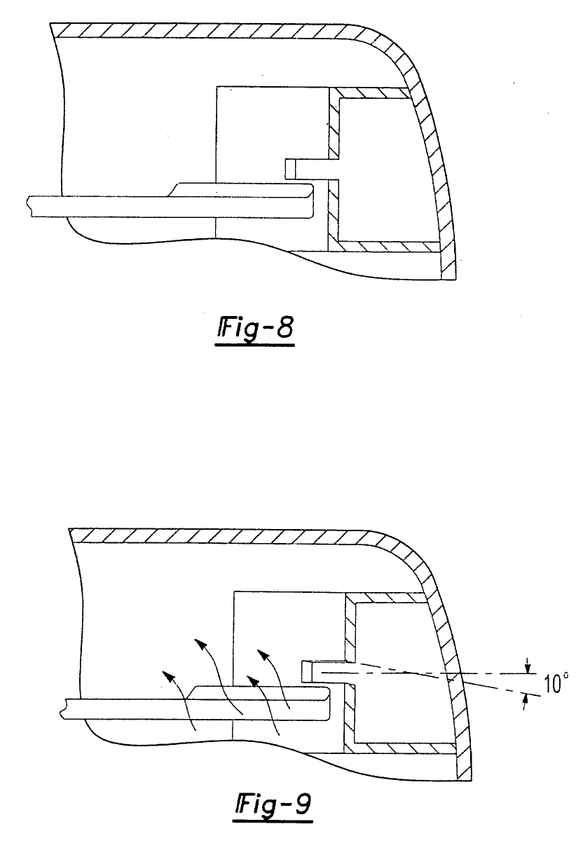

FIGS. 6-8 illustrate various embodiments. Resonator 40 is shown mounted to outer wall 66 of mower deck 34, such that enclosed volume 44 is abutted on one side by outer surface 66, and on the other by inner cover surface 68 of annular cover 60. Resonator 40 can be secured to inner cover surface 68 or outer surface 66, or both, by any suitable attachment technique, such as those described above. Resonator 40 is thus located outside the primary mowing chamber, such that only orifice tube 42 extends through aperture 58 in mower deck 34. Resonator 40 is otherwise constructed as described for the first embodiment, and similar design considerations apply. Annular cover 60 surrounds resonators 40 around the periphery of mower deck 34 to protect them from damage due to any contact with external objects.

One potential consideration with resonators having an orifice near the mowing chamber is that grass clippings and other debris may become lodged within orifice tube 42 or fall into enclosed volume 44. As such, it may be necessary to design resonator 40 to prevent this possible problem. Turning now to FIG. 9, a mower deck according to various embodiments is illustrated. In the various embodiments, which is shown as a modification of FIGS. 1-3, the inner wall 62 of resonator 40 is angled upwards 10 degrees, such that orifice tube 42 is also angled upwards 10 degrees. As such, the flow of grass clippings (arrows) will be less likely to become trapped on the upper edge of orifice tube 42 and fall into enclosed volume 44. Rather, the flow of grass clippings will generally continue upwards, out of mowing unit 18, according to the well known function of grass clipping removal. Mesh screen 70 may also be provided, which blocks grass clippings and other pieces of large debris from entering orifice tube 42 and falling into resonator 40, but still allows air to flow freely in and out of resonator 40.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A rotary mower deck comprising:
a mowing chamber;
a driveshaft extending generally vertically into the mowing chamber;
at least one cutting blade secured to the driveshaft within the mowing chamber for rotation therewith; and
at least one resonator attached to the mowing chamber, the resonator having a body and an orifice, the orifice being in proximity to an end of the cutting blade.

2. The rotary mower deck of claim 1 wherein a resonant frequency of the resonator is approximately equal to a blade pass frequency of the cutting blade.

3. The rotary mower deck of claim 1 wherein the resonator body is within the mowing chamber.

4. The rotary mower deck of claim 1 wherein the resonator body is outside the mowing chamber.

5. The rotary mower deck of claim 1 wherein the resonator orifice is generally aligned in a direction toward the driveshaft.

6. The rotary mower deck of claim 1 wherein the resonator orifice is generally aligned in a direction toward an upper portion of the mower deck.

7. A rotary mower deck comprising:
a mowing chamber;
a driveshaft extending vertically into the mowing chamber;
at least one cutting blade secured to the driveshaft within the mowing chamber for rotation therewith; and
a perforated metal ring mounted to an inner surface of the mowing chamber and enclosing a sound absorbing material with the inner surface, the orifices of the perforated metal ring being in proximity to the end of the cutting blade.

8. The rotary mower deck of claim 7 wherein the sound absorbing material is a synthetic vitreous material such as rock or mineral wool.

10. The rotary mower deck of claim 7 wherein the orifices of the perforated metal are generally aligned in a direction toward the driveshaft.

11. The rotary mower deck of claim 7 wherein the orifices of the perforated metal are generally aligned in a direction toward an upper portion of the mower deck.

12. A mower comprising:
a frame supported on a plurality of wheels;
a primary mover supported by the frame for providing motive force to the mower;
rotary mower deck supported by the frame and including:
a mowing chamber;
a driveshaft extending vertically into the mowing chamber;
at least one cutting blade secured to the driveshaft within the mowing chamber for rotation therewith; and
at least one resonator attached to the mowing chamber, the resonator having a body and an orifice, the orifice being in proximity to an end of the cutting blade.
the resonator is approximately equal to a blade pass frequency of the cutting blade.

13. The rotary mower deck of claim 12 wherein the resonator body is within the mowing chamber.

14. The rotary mower deck of claim 13 wherein the resonator orifice is generally aligned in a direction toward the driveshaft.

15. The rotary mower deck of claim 13 wherein the resonator orifice is generally aligned in a direction toward an upper portion of the mower deck.

16. The rotary mower deck of claim 15 wherein the resonator body is outside the mowing chamber.

17. The rotary mower deck of claim 16 wherein the resonator orifice is generally aligned in a direction toward the driveshaft.

18. The rotary mower deck of claim 16 wherein the resonator orifice is generally aligned in a direction toward an upper portion of the mower deck.

19. A mower comprising:
a frame supported on a plurality of wheels;
a primary mover supported by the frame for providing motive force to the mower;
rotary mower deck supported by the frame and including:
a mowing chamber;
a driveshaft extending vertically into the mowing chamber;
at least one cutting blade secured to the driveshaft within the mowing chamber for rotation therewith; and
a perforated metal ring mounted to an inner surface of the mowing chamber and enclosing a sound absorbing material with the inner surface, the orifices of the perforated metal ring being in proximity to the end of the cutting blade.

20. The rotary mower deck of claim 19 wherein the sound absorbing material is a synthetic vitreous material such as rock or mineral wool.

21. The rotary mower deck of claim 20 wherein the orifices of the perforated metal are generally aligned in a direction toward the driveshaft.
